(19) United States
(12) Patent Application Publication
(10) Pub. No.: US 2006/0155666 A1
(43) Pub. Date: Jul. 13, 2006

(54) Device for storing a list of elements and method of storing an element in one such device

(75) Inventor: Eric Diehl, Liffre (FR)

Correspondence Address: THOMSON LICENSING INC., PATENT OPERATIONS, PO BOX 5312, PRINCETON, NJ, 08543-5312, US

(73) Assignee: THOMSON Licensing S.A., F-92100 Boulogne-Billancourt (FR)

(21) Appl. No.: 10/530,899

(22) PCT Filed: Oct. 14, 2003
(86) PCT No.: PCT/EP03/50718

§ 371 Date: Oct. 26, 2005

(30) Foreign Application Priority Data
Oct. 16, 2002 (FR) 0213333

(51) Int. Cl. G06F 17/30

(52) U.S. Cl. 707/1

(57) ABSTRACT

The invention relates to a device for memorizing a list of items intended to memorize any item that was last presented to it. It comprises a first memory and means responsible, when the first memory is full and when a new item has to be memorized, for randomly selecting an item memorized in the first memory to remove this selected item and to memorize the new item presented. It also relates to a method for memorizing an item in such a device.

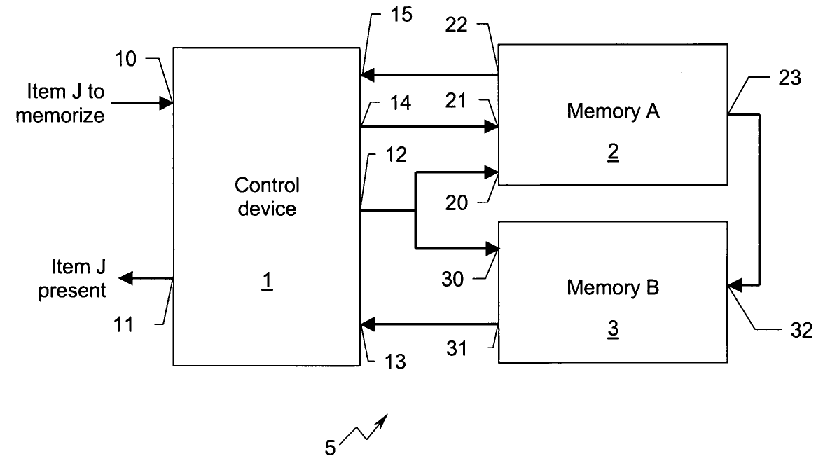

### FIELD OF THE INVENTION

The present invention generally relates to the field of security in systems that require the memorization of a secure log. It particularly relates to a device for memorizing a list of items and a method for memorizing an item in such a device.

### BACKGROUND ART

To prevent illegal attempts to access data or fraudulent operations on data, it is common for systems that are said to be “secure” to keep an event log or a list of operations carried out.

A typical example concerns a recording device that is only authorised to make one copy (or a limited number of copies) of any content that it may record. This is necessary for digital recording devices to prevent the proliferation of illegal copies while authorizing copying for personal use. An immediate solution to ensure this consists of keeping, within the recording device, a list of all the contents (or more specifically a list of identifiers of all the content) already recorded by it. Each time the recording device receives a command to record a specific content, it checks beforehand that this content is not present in the list of contents already recorded. If the content (or more specifically its identifier) is contained in the list, the recording device refuses to record it.

The problem that arises in the above example is that the potential number of contents to record has no limit. Hence, for the security of the system to be ensured the list of contents already recorded must also have no limit, which is not possible for consumer electronic devices. In this type of device, a FIFO (acronym of “First In First Out”) type memory is generally used to memorize a list such as above.

However, if the purpose of this list is to provide a certain security in a system, as in the above example where the list is held to prevent the illegal copying of contents, or else for a revocation list containing the identifiers of cryptographic keys or devices that are no longer considered as compliant or legal by a trustworthy organisation, then the solution that consists in memorizing such a list in a FIFO memory is unsatisfactory. Indeed, if the size of the memory enables it to memorize n items, all a pirate has to do is present n+1 items to the device memorizing the list to be sure that the first item memorized is removed from the list, which obviously compromises the security of the system.

SUMMARY OF THE INVENTION

The present invention aims to solve the above-mentioned problems.

Its subject is a device for memorizing a list of items intended to memorize any item last presented to the device. This device comprises a first memory and further contains according to the invention means responsible, when the first memory is full and when a new item has to be memorized, for randomly selecting an item memorized in the first memory to remove this selected item and to memorize the new item presented.

According to a particular characteristic of the invention, the device can memorize N items, N being a natural integer, and it further comprises a second memory designed to continually memorize the M items that were last presented to said device, M being a natural integer below N, the first memory being intended to memorize the N-M other items.

Thanks to the device according to the invention, even if more than N items to memorize are presented to it, there is no means of knowing at the end which item(s) are no longer found in the device.

According to another characteristic, the device is also adapted to supply information indicating whether the item that was presented to the device is already present in the device.

According to another characteristic, the device only contains one copy of each item memorized.

According to a particular aspect of the invention, the device also memorizes, for each item, the number of times that this item has been presented to it.

According to another aspect of the invention, the device is adapted to supply information indicating whether the item that was last presented to it has already been presented to it a number of times that exceeds a predetermined number.

The invention also relates to a method for memorizing an item in a device such as described above. It comprises the steps consisting in (a) receiving an item that is presented to the device; (b) verifying whether this item is already present in the device; and
should said verification be positive, designating the item as an item last memorized, and
should said verification be negative, memorizing the item in the device.

According to one particular embodiment, in the event of negative verification in step (b):
if the second memory is not full, the item received is memorized in the second memory; and
if the second memory is full:
   i) the oldest item memorized in the second memory is transferred to the first memory;
   ii) the received item is memorized in the second memory (2); and
   iii) if the first memory is full, then an item memorized in the first memory is selected randomly to be removed such that the oldest item memorized in the second memory can be transferred to the first memory.

### BRIEF DESCRIPTION OF THE DRAWINGS

Other characteristics and advantages of the invention will emerge with the description of a non-restrictive particular embodiment of the invention, clarified by the annexed single FIGURE that diagrammatically shows a memorization device according to the invention.

### DETAILED DESCRIPTION OF EMBODIMENTS OF THE INVENTION

The memorization device of the invention is designed to contain a maximum of N items, for instance the identifiers of the contents to be recorded. This device, which is reference 5 on the single FIGURE, is notably integrated into a digital recording device.

The device 5 comprises two memories A and B. Memory A, with the reference 2, contains a maximum of M items and memory B, with the reference 3, contains a maximum of P items, such that N=M+P, where N, M and P are natural integers.

Memory A always contains the last M items that were memorized in the device. As for memory B, it contains items that were memorized before the last M items.

When a new item J is presented to the device, for example, when the recording device receives a command to record new content, the content identifier (corresponding to the item J) is presented to the memorization device 5 to verify whether or not it is already contained in the list memorized in device 5.

If the item J is already present in the memory A, then it is marked in the memory A as the last item memorized. If the item J is already present in the memory B, then it is moved into the memory A to the location of the last item memorized. In both cases, the device 5 therefore returns the information that the item J is present.

If the item J is not present in memory A or memory B, then J is memorized in memory A. If memory A already contains M items, then the oldest item memorized in the memory A is transmitted to the memory B to be recorded in it. It is deleted from the memory A at the same time to create room for the item J. If the memory B is also full, i.e. if it already contains P items, then an item already memorized in the memory B is selected at random to be deleted and replaced by the oldest item in the memory A. Device 5 then returns the information according to which the item J was not present but is now memorized.

By referring more specifically to the single figure, the memorization device 5 comprises a control device 1 and two memories A and B with references 2 and 3 respectively.

The control device 1 has three inputs 10, 13 and 15 and three outputs 11, 12 and 14. Input 10 receives the item J to memorize, which is then sent to output 12 of the control device.

Output 11 is a boolean signal that indicates whether the item J is already memorized in the memorization device 5. The signal at output 11 is “1” (for “true”) if the item J is already memorized and “0” (for “false”) otherwise. The inputs 13 and 15 and output 14 are also boolean signals that will be described below.

Memory A has two inputs 20 and 21 and two outputs 22 and 23. Input 20 receives the output 12 of the control device, which sends it the item J to be memorized or whose presence in memory A must be determined. The input 21, which is connected to the output 14 of the control device 1, is a boolean signal that indicates, when its value is “1” (“true”), that the item J received at input 20 must be memorized in the memory A.

Output 22 of the memory A is also a boolean signal that indicates, when its value is “1” (“true”), that the item J presented at input 20 is already present in the memory A. This output 22 is linked to the input 15 of the control device 1.

Output 23 of the memory A is used only when the memory A is full and when a new item present at the input 20 must be memorized. In this case, the output 23 supplies the oldest item memorized in the memory A. Otherwise, output 23 does not supply any signal.

As for the memory B, it has two inputs 30 and 32 and one output 31. The input 30 is linked to the output 12 of the control device 1 and receives the item J whose presence in the memory B must be verified. The output 31 is a boolean signal with a value of “1” (“true”) when the item J received at the input 30 is present in the memory B; it is linked to the input 13 of the control device 1.

As for the input 32 of the memory B, it receives the item to memorize that comes from memory A when this memory is full. The input 32 is linked for this purpose to the output 23 of the memory A.

The assembly operates in the following manner. When the control device 1 receives an item J on its input 10, it supplies this item J at its output 12. If this item J is present in the memory A, a signal “1” (for “true”) is received on the input 15 of the control device 1. If the item J is present in the memory B, a signal “1” (for “true”) is received at the input 13 of the control device 1.

If the two boolean signals received at the inputs 13 and 15 of the control device have the value “0” (i.e. “false”), it means that the item J received at the input 10 is not present in the memory A or the memory B. In this case, the control device 1 supplies a “0” signal (“false”) at its output 11 and a “1” signal at its output 14 meaning that the item J must be recorded in the memory A.

If the boolean signal received at input 15 has a value “1” (“true”), meaning that the item J is already present in the memory A, then the control device 1 supplies a “1” signal at its output 11 and a “0” signal at its output 14.

If the boolean signal received at input 13 has a value “1” (“true”), meaning that the item J is already present in the memory B, then the control device 1 supplies a “1” signal at its output 11 and a “1” signal at its output 14.

When the memory A receives an item J at its input 20, it verifies firstly whether it already has this item. If the item J is already present in the memory A, then the signal at output 22 takes the value “1” (“true”). The item J is then designated as the item last memorized by the memory A. For instance, the item J is placed at the top of the stack if the memory A has a stack structure, or else an index table of the items stored in the memory is kept updated.

Otherwise (J not present in the memory A), the output 22 takes the value “0” (“false”).

When the signal received at the input 21 of the memory A is “true” (value “1”), meaning that the item J present at the input 20 must be memorized in the memory A, there are two possibilities. Either the memory A contains fewer M items and it memorizes the new item J that becomes the item last memorized. Or the memory A already contains M items. In the latter case, it places the oldest item on its output 23 and removes it from its memory to memorize the new item J as the most recent item.

The memory B has a different behaviour from memory A. When an item J is received at the input 30 of the memory B, this memory checks whether it already contains this item J. If this is true, then the output 31 takes the value “1”, otherwise (J not present in the memory B), the output 31 takes the value “0”.

If an item J coming from the memory A is received at input 32 of the memory B, then there are two possibilities: either the signal 31 is “true” (value “1”) or the signal 31 is “false” (value “0”).

If the signal 31 is “true”, then the new item received at the input 32 of the memory B replaces the item whose value is present at the input 30 (which is moved to the memory A).

If the signal 31 is “false”, there are still two possibilities: either the memory B contains fewer P items and it memorizes the new item J; or the memory B already contains P items, i.e. it is full. In the latter case, it selects an item already memorized in the memory B at random and removes it to memorize the new item received at its input 32 in place of the randomly selected item.

Hence, the memory B empties in a random manner. A pirate wanting to eliminate an item of the memorization device 5 must therefore make many more attempts than in the case of a simple FIFO memory type. Indeed, if the overall size of the memory is N items, a pirate must carry out on average many more than N attempts to eliminate an item from the memory.

It should be noted that the memories A and B, which are represented separately in the single figure, can in practice be two subassemblies of the same physical memory.

The invention is not limited to the embodiment that has been described above. As a variant, the memorization device 5 can indeed comprise a memory A of null size. In another variant, the user is able to present each item to the memorization device a given number of times. For example, if this device is integrated into a recording device, and this recording device is authorised to make a number x of copies of each content, the memory will store, with each content identifier already recorded by the appliance, the number y of times that the content was presented to the device for recording. When the given content presentation number y reaches the number x, then it is no longer possible to record this content and the memorization device 5 will return a corresponding item of information to the recording device.

1. Device for memorizing a list of items intended to memorize any item last presented to it and capable of memorizing N items, N being a natural integer, wherein said device comprises:
a first memory designed to continually memorize the M items that were last presented to said device, M being a natural integer below N, and
a second memory (3), intended to memorize the N-M other items
said device additionally comprising means responsible, when the second memory is full and when a new item has to be memorized in said device, for randomly selecting an item memorized in the second memory to remove this selected item and to memorize the new item presented in said device.

2. Device according to claim 1 being also adapted to supply information indicating whether the item that was last presented to it is already present in said device.

3. Device according to claim 1, being adapted to contain only one copy of each item memorized.

4. Device according to claim 1, wherein it also memorizes, with each item, the number of times that this item has been presented to it.

5. Device according to claim 4, being further adapted to supply information indicating whether the item that was last presented to it has already been presented to it for a number of times that exceeds a predetermined number.

6. Method of memorizing an item in a device according to claim 1, said method comprising the steps consisting in
(a) receiving an item that is presented to the device;
(b) verifying whether said item is already present in said device; and
should said verification be positive, designating said item as an item last memorized, and
should said verification be negative, memorizing said item in the device.

7. Method according to claim 6, wherein in the event of negative verification in step (b):
if the first memory is not full, the item received is memorized in the first memory; and
if the first memory is full:
i) the oldest item memorized in said first memory is transferred to the second memory; and
ii) the item received is memorized in the first memory; and
iii) if the second memory is full, then an item memorized in said second memory is selected at random to be removed so that the oldest item memorized in said first memory can be transferred to said second memory.
